(19) United States
(12) Patent Application Publication
(10) Pub. No.: US 2013/0337884 A1
(43) Pub. Date: Dec. 19, 2013

(54) Gaming System and a Method of Gaming

(71) Applicants: Casey Lyle Condron, Las Vegas, NV (US); Peter Jude Mastera, Henderson, NV (US); Scott Monroe Stewart, Las Vegas, NV (US)

(72) Inventors: Casey Lyle Condron, Las Vegas, NV (US); Peter Jude Mastera, Henderson, NV (US); Scott Monroe Stewart, Las Vegas, NV (US)

(21) Appl. No.: 13/525,759

(22) Filed: Jun. 18, 2012

(51) Int. Cl. A63F 9/24; A63F 13/00

(52) U.S. Cl. 463/20

(57) ABSTRACT

A gaming system is disclosed that comprises a selector arranged to select a plurality of symbols for display in a plurality of display position groups. The gaming system is arranged to facilitate selection of at least one display position group, and so as to make symbols in the selected display position group(s) less visible than symbols in other non-selected display position groups. The gaming system is also arranged so as to determine a first game outcome based on the visible symbols. After the first game outcome is determined, the symbols in the selected display position group(s) are made as visible as symbols in the non-selected display position groups, and the system then determines a second game outcome based on all symbols now visibly displayed.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system and to a method of gaming.

It is known to provide a gaming system arranged to randomly display several symbols from a predetermined set of symbols and to determine a game outcome such as a game win based on the displayed symbols.

Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### BRIEF SUMMARY OF THE INVENTION

In accordance with a first aspect of the present invention, there is provided a gaming system comprising:

a selector arranged to select a plurality of symbols from a set of symbols for display in a display position area in a plurality of display position groups;

the gaming system being arranged to facilitate selection of at least one display position group;

the gaming system being arranged so as to make symbols in the at least one selected display position group less visible than symbols in other non-selected display position groups; and

the gaming system being arranged so as to:
determine a first game outcome based on symbols displayed in the non-selected display position groups when symbols of the at least one selected display position group are less visible than symbols in the non-selected display position groups;
after the first game outcome is determined, to make the symbols in at least one selected display position group as visible as symbols in the non-selected display position groups; and
after making the symbols in the at least one selected display position group as visible as symbols in the non-selected display position groups, determine a second game outcome based on symbols displayed in the non-selected display position groups and symbols displayed in the at least one selected display position group that has been made as visible as symbols in the non-selected display position groups.

In one embodiment, the gaming system comprises at least one shutter member disposable in a first configuration wherein the at least one selected display position group is concealed, and in a second configuration wherein the at least one selected display position group is not concealed.

In one embodiment, each display position group has an associated shutter member movable between a closed position wherein the associated display position group is concealed and an open position wherein the associated display position group is not concealed.

In one embodiment, the at least one shutter member is operable in a substantially transparent state wherein at least one display position group is visible through the shutter member, and in a substantially non-transparent state wherein the at least one display position group is not visible through the shutter member. Each display position group may have an associated shutter member operable in a transparent or non-transparent state.

In one embodiment, the gaming system is arranged so as to selectively make symbols in the at least one selected display position group less visible than, or as visible as, symbols in non-selected display position groups by modifying lighting associated with the at least one selected display position group.

In one embodiment, the gaming system is arranged to automatically select the at least one display position group to be made less visible than symbols in non-selected display position groups.

In one embodiment, the gaming system is arranged to facilitate selection by a player of the at least one display position group to be made less visible than symbols in non-selected display position groups.

In one embodiment, the gaming system comprises a touch screen and/or one or more buttons usable by a player to select the at least one display position group to be made less visible than symbols in other non-selected display position groups.

In one embodiment, the gaming system is arranged to facilitate selection of a plurality of display position groups, and to make symbols in the selected display position groups less visible than symbols in non-selected display position groups. With this embodiment, after the first game outcome is determined, the gaming system may be arranged to make the symbols in all selected display position groups as visible as symbols in the non-selected display position groups.

Alternatively, after the first game outcome is determined, the gaming system may be arranged to:

sequentially make the symbols in the selected display position groups as visible as symbols in the non-selected display position groups, and

after making the symbols in each of the selected display position groups as visible as symbols in the non-selected display position groups, determine subsequent respective game outcomes based on symbols displayed in the non-selected display position groups and symbols displayed in the selected display position groups that have been made as visible as symbols in the non-selected display position groups.

In one embodiment, after the first game outcome is determined, the gaming system may be arranged to:

facilitate selection by a player of at least one of the selected display position groups to be made as visible as symbols in the non-selected display position groups.

In one embodiment, the gaming system comprises a plurality of reels, each reel being associated with a display position group. The reels may be physical or virtual reels.

The gaming system may be operable in base game mode or special game mode, wherein:

in base game mode, at least one display position group to be made less visible than symbols in non-selected display position groups is not selected; and

in special game mode, at least one display position group to be made less visible than symbols in other non-selected display position groups is selected.

In one embodiment, the gaming system is arranged to commence special game mode when a trigger condition occurs.

In one embodiment, the gaming system is arranged to commence special game mode in response to player input, based on the amount or type of bet placed, or when a special game is purchased by a player.

The trigger condition may be display of a particular symbol, or display of a defined symbol combination.

In accordance with a second aspect of the present invention, there is provided a method of gaming comprising:

selecting a plurality of symbols from a set of symbols for display in a display position area in a plurality of display position groups;

selecting at least one display position group;

making symbols in the at least one selected display position group less visible than symbols in other non-selected display position groups; and

determining a first game outcome based on symbols displayed in the non-selected display position groups when symbols of the at least one selected display position group are less visible than symbols in the non-selected display position groups;

after the first game outcome is determined, making the symbols in at least one selected display position group as visible as symbols in the non-selected display position groups; and

after making the symbols in the at least one selected display position group as visible as symbols in the non-selected display position groups, determining a second game outcome based on symbols displayed in the non-selected display position groups and symbols displayed in the at least one selected display position group that has been made as visible as symbols in the non-selected display position groups.

In accordance with a third aspect of the present invention, there is provided a computer readable data storage device having a computer readable program code embodied therein for causing a computer to operate in accordance with the gaming system of the first aspect.

### BRIEF DESCRIPTION OF SEVERAL VIEWS OF THE DRAWINGS

The present invention will now be described, by way of example only, with reference to the accompanying drawings, in which:

FIG. 1 is a schematic block diagram of components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention wherein the gaming system is implemented over a network;

FIG. 7 is a flow diagram illustrating game play of a gaming system in accordance with an embodiment of the present invention; and

FIGS. 8a to 8c are diagrammatic representations of a display area of a gaming system in accordance with an embodiment of the present invention shown during implementation of a game.

### DETAILED DESCRIPTION OF THE INVENTION

The present gaming system implements a probabilistic type game wherein a plurality of symbols are selected and displayed in a plurality of display position groups. During the game, or during implementation of a feature game, at least one of the display position groups is selected and obscured or the otherwise made less visible than the other display position groups. A first game outcome is determined on the basis of symbols displayed when one or more of the display position groups is obscured or otherwise made less visible. At least one of the obscured/less visible display position groups is then revealed or otherwise made as visible as the other display position groups, and a second game outcome is determined on the basis of the symbols displayed.

In this way, at least 2 game outcomes are determined, one when at least one symbol group obscured or otherwise made less visible, and the other when the at least one symbol group is revealed or otherwise made as visible as the other display position groups.

In one embodiment, a mechanical shutter is disposed over each of the reels, and each shutter is controllable so as to selectively move between a closed position wherein the shutter obscures a respective reel or an open position wherein the shutter does not obscure the respective reel and the reel is revealed.

In an alternative embodiment, at least one virtual shutter device is disposed over the reels, the virtual shutter device being controllable in response to an electronic signal so as to be disposable, at selected parts of the device, in a substantially transparent state wherein one or more reels are visible through the device or a substantially opaque state wherein one or more reels are not visible through the device.

In a further alternative embodiment, instead of providing a mechanical or virtual shutter to obscure one or more of the reels, the gaming system may be arranged to modify the lighting at one of more reels so that the symbols on one or more of the reel(s) are noticeably less visible than symbols on the other reels.

In one conventional type of gaming machine, a spinning reel type game comprises a display area including 15 display positions, with each display position including one symbol. The display positions are arranged in five vertically disposed reels, with each reel corresponding to a display position group, and each reel having three visible display positions. After the reels are spun and subsequently stopped, the display positions show a random selection of symbols.

Generally, with such games, a plurality of win patterns in the form of win lines are defined which extend across the reels and include one display position from each reel. Typically the symbols that are disposed in a win line are compared with winning symbol combinations defined in a pay table so as to determine whether a player of the game should receive an award. For example, if winning symbol combinations are based on poker hands, a particular prize would be awarded if the win line comprises four aces. Other winning symbol combinations and corresponding prizes may also be defined.

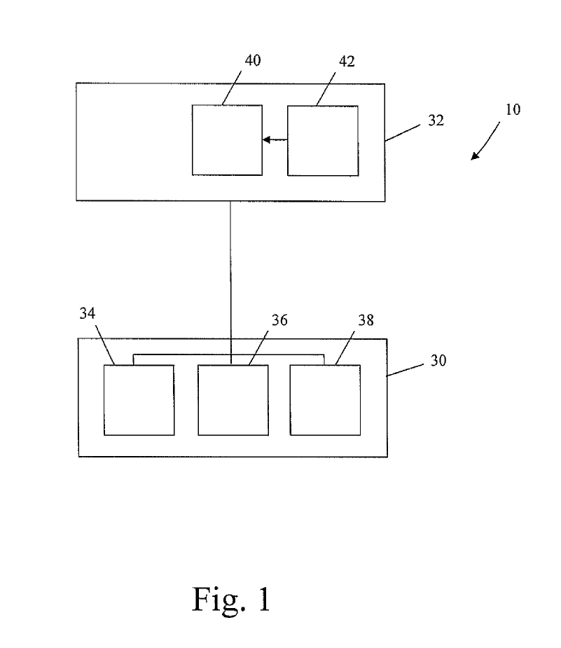

Referring to FIG. 1 of the drawings, there is shown a schematic block diagram of components of a gaming system 10 arranged to implement a probabilistic game of the type wherein several symbols from a set of symbols are randomly displayed, and a game outcome is determined on the basis of the displayed symbols. The system is of the type including multiple game modes, such as normal game mode wherein a base game is implemented and special game mode wherein a feature game is implemented.

The components comprise a player interface 30 and a game controller 32. The player interface 30 is arranged to enable interaction between a player and the gaming system and for this purpose includes input/output components required for the player to enter instructions and play the game.

Components of the player interface 30 may vary but will typically include a credit mechanism 34 to enable a player to input credits and receive payouts, one or more displays 36 which may comprise a touch screen, and a game play mechanism 38 arranged to enable a player to input game play instructions.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

With the present embodiment, a mechanical spinning reel type game is implemented during normal game mode. The set of symbols used include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

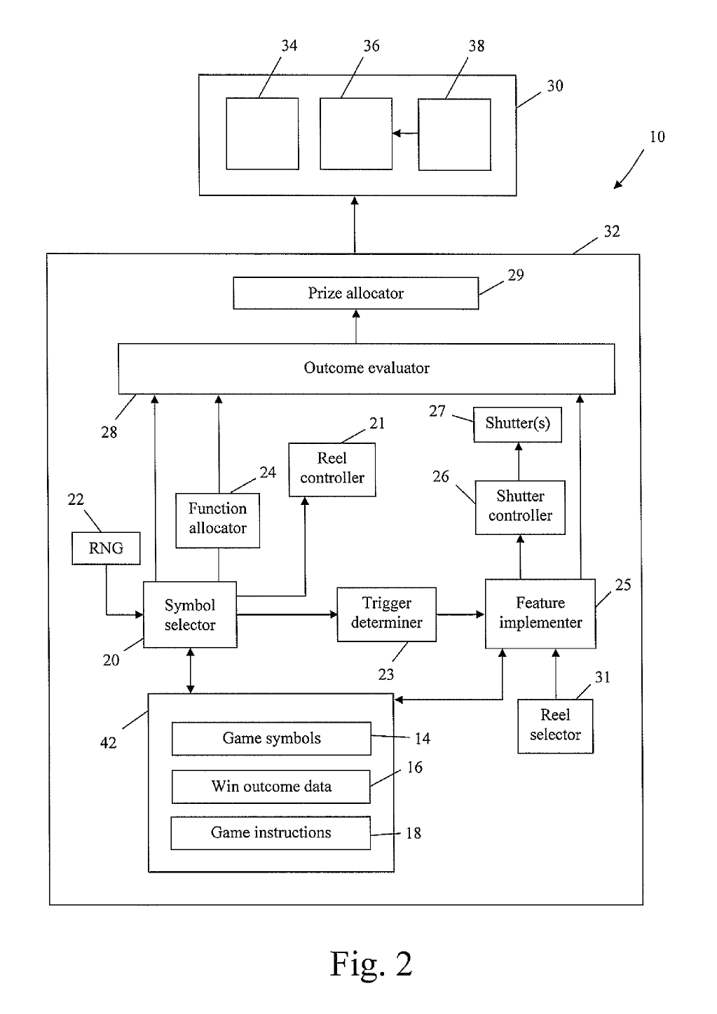

A functional diagram illustrating operative components of the game controller 32 is shown in FIG. 2.

The memory 42 is arranged to store symbols data 14 indicative of selectable symbols, win outcome data 16 indicative of win condition requirements games implemented by the system, and game instruction data 18 indicative of game instructions usable by the gaming machine 10 to control operation of the games.

The game controller 32 includes a symbol selector 20 which is arranged during normal game mode to select several symbols for display to a player in a plurality of display positions on a plurality of reels, and a reel controller 21 arranged to control spinning and stopping of the reels so that the reels stop with the selected symbols displayed. In this example, the selection carried out by the symbol selector 20 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

With this embodiment, the game controller 32 also comprises a trigger determiner 23 arranged to determine whether a trigger condition exists, and a feature implementer 25 arranged to implement a feature game when a trigger condition is determined to exist.

For use during the feature game, the gaming system 10 also includes a shutter 27 for each of the reels, and a shutter controller 26 arranged to control the shutters in order to selectively dispose each of the shutters in an open configuration or a closed configuration.

In this example, the shutters 27 are mechanical shutters selectively individually movable between a first position wherein the shutter conceals a reel and a second position wherein the shutter does not conceal the reel.

However, it will be understood that other arrangements are possible. For example one or more virtual shutters may be provided, each virtual shutter being electronically controllable so as to dispose the shutter or part of the shutter in a substantially transparent or substantially opaque state.

During a feature game, the feature implementer 25 instructs the shutter controller 26 to close one or more of the shutters 27 so that at least one selected reel is concealed and is therefore not visible to a player.

The reel that is concealed may be selected by the gaming system, for example randomly using the random number generator 22 or based on a defined process, or may be selected by a player using a reel selector 31. The reel selector 31 may comprise a touch screen or one or more buttons.

The game controller 32 also comprises an outcome evaluator 28 which, in accordance with game instructions 18, determines game outcomes based on the symbols selected for display to the player by the symbol selector 20 during normal game mode when all reels are visible, and during special game mode when at least one selected reel is obscured by a shutter or otherwise made less visible and when the at least one selected reel is not obscured by a shutter.

The game controller 32 also comprises a prize allocator 29 arranged to allocate a prize to a player when a winning outcome exists.

In the present embodiment, the symbol selector 20, the trigger determiner 23, the function allocator 24, the feature implementer 25, the reel controller 21, the shutter controller 26, the outcome evaluator 28, and the prize allocator 29 are at least partly implemented using the processor 40 and associated software although it will be understood that other implementations are envisaged.

The gaming system 10 can take a number of different forms.

In a first form, a player operable gaming device in the form of a stand alone gaming machine is provided wherein all or most components required for implementing the game are present in the gaming machine.

In a second form, a distributed architecture is provided wherein some of the components required for implementing the game are present in a player operable gaming device and some of the components required for implementing the game are located remotely relative to the gaming device. For example, a “thick client” architecture may be used wherein part of the game is executed on a player operable gaming terminal and part of the game is executed remotely, such as by a gaming server; or a “thin client” architecture may be used wherein most of the game is executed remotely such as by a gaming server and a player operable gaming terminal is used only to display audible and/or visible gaming information to the player and receive gaming inputs from the player.

However, it will be understood that other arrangements are envisaged. For example, an architecture may be provided wherein a gaming device is networked to a device server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

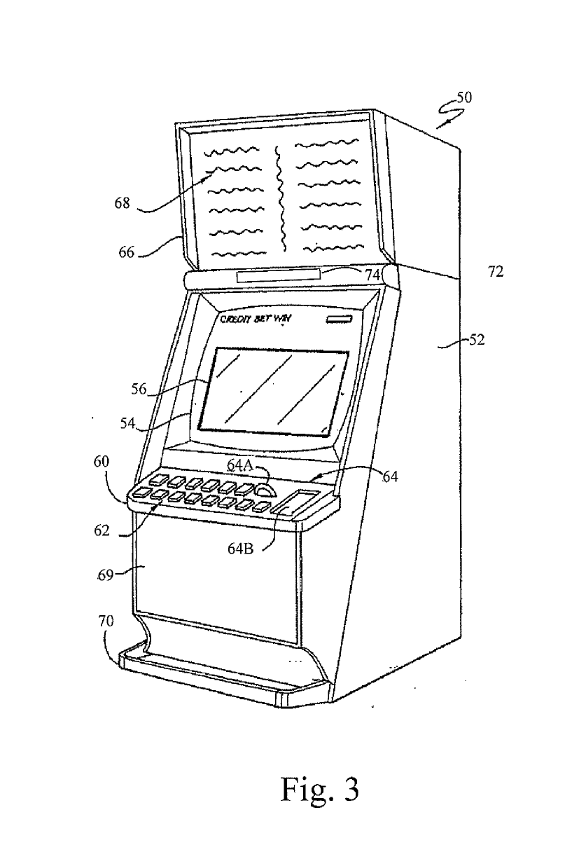

A gaming system in the form of a stand alone gaming machine 50 is illustrated in FIG. 3. The gaming machine 50 includes a console 52 having a display device 54 on which is displayed representations of a game 56 that can be played by a player. A mid-trim 60 of the gaming machine 50 houses a bank of buttons 62 for enabling a player to interact with the gaming machine, in particular during gameplay. The mid-trim 60 also houses a credit input mechanism 64 which in this example includes a coin input chute 64A and a bill collector 64B. Other credit input mechanisms may also be employed, for example, a card reader for reading a smart card, debit card or credit card.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The top box 66 may also include a display, for example a video display unit, which may be of the same type as the video display unit, or of a different type.

Typically, during operation of the game, the reels first appear to rotate then stop with typically three symbols visible on each reel. Game outcomes are determined on the basis of the visible symbols together with any special functions associated with the symbols.

A player marketing module (PMM) 72 having a display 74 is connected to the gaming machine 50. The main purpose of the PMM 72 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

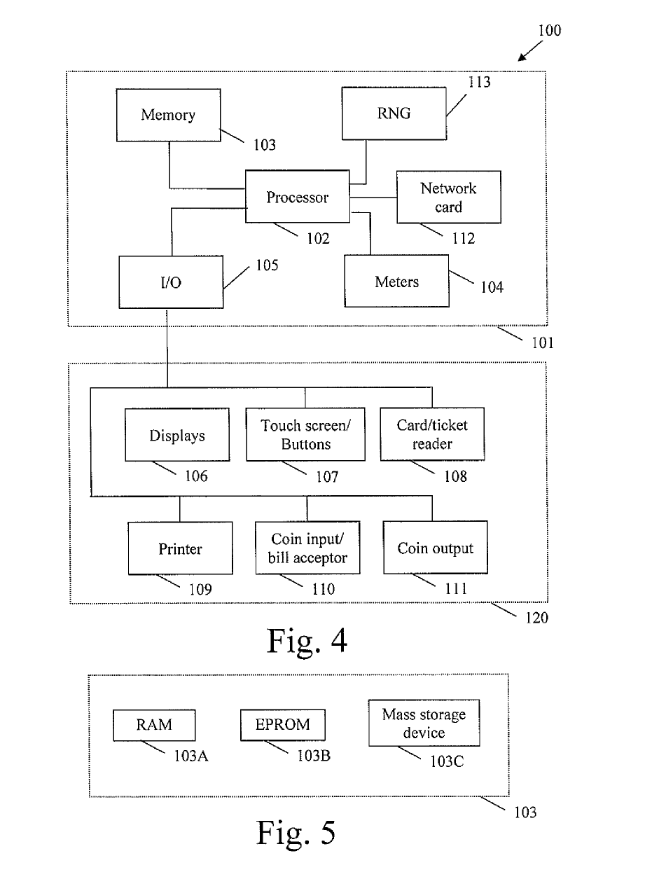

FIG. 4 shows a block diagram of operative components of a gaming device 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

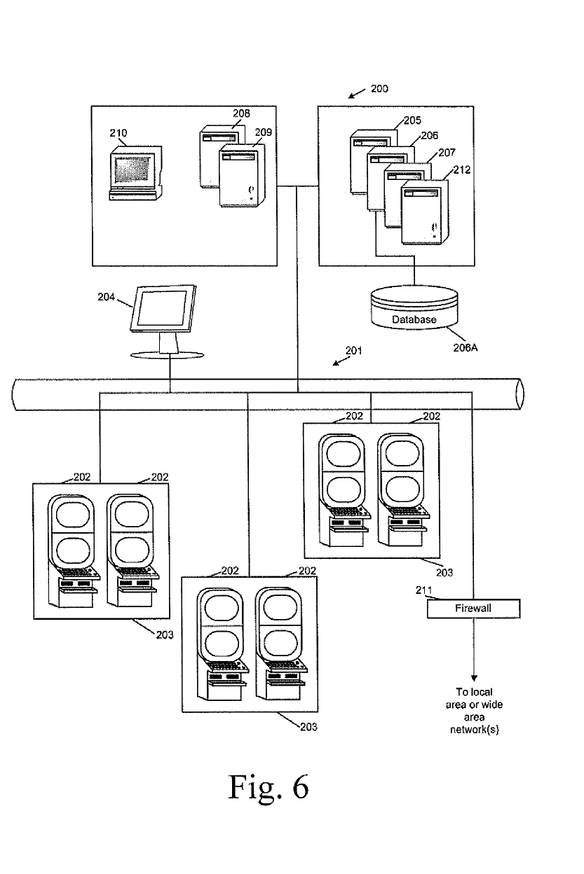

FIG. 6 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106; a touch screen and/or bank of buttons 107 including at least one input device, such as at least one button; a card and/or ticket reader 108; a printer 109; a bill acceptor and/or coin input mechanism 110; a coin output mechanism 111; and a shutter 86. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40,100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine.

Alternatively, a separate random number generator server could be provided.

Examples of specific implementations of the gaming system will now be described in relation to a stand alone gaming machine 50 although it will be understood that implementation may also be carried out using other gaming system architectures such as a network architecture of the type shown in FIG. 6.

The gaming system is operable in normal game mode and special game mode and may be arranged to commence special game mode when a predetermined game outcome occurs. Special game mode may comprise one or more free games.

Special game mode may commence automatically on the basis of a game event occurring during a game such as display of a particular symbol, based on game outcomes determined by the gaming system, or may be prompted by a player pressing a button on the gaming system 10 after the player has identified that a game outcome corresponding to special game mode requirements has occurred.

The gaming system 10 may also be arranged so as to determine eligibility for special game mode, for example based on the amount or type of bet placed, based on particular time periods and so on.

Special game mode may also be arranged to commence when a special game is purchased by a player.

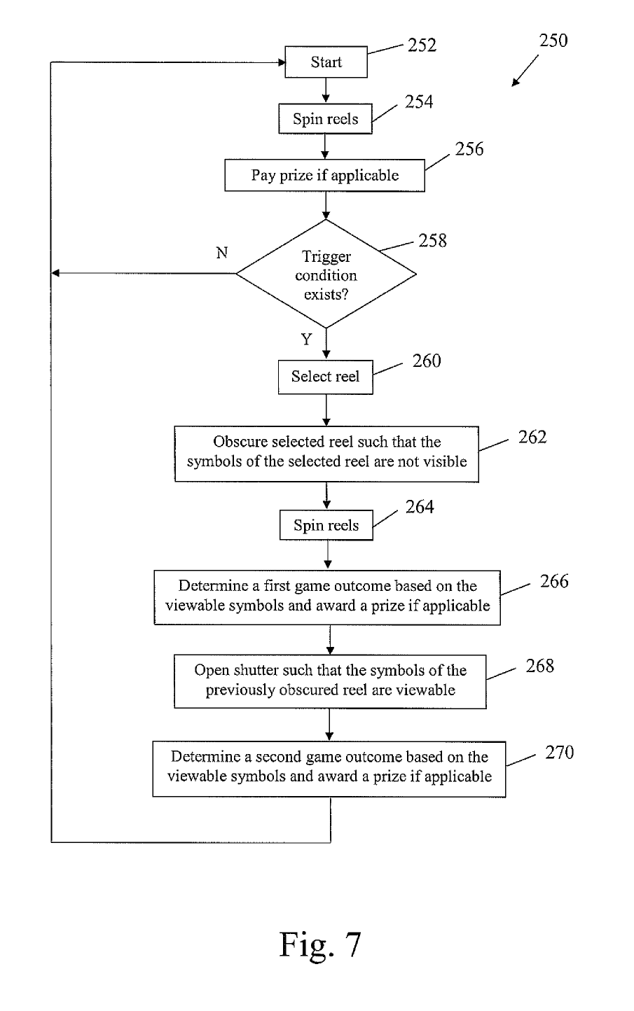

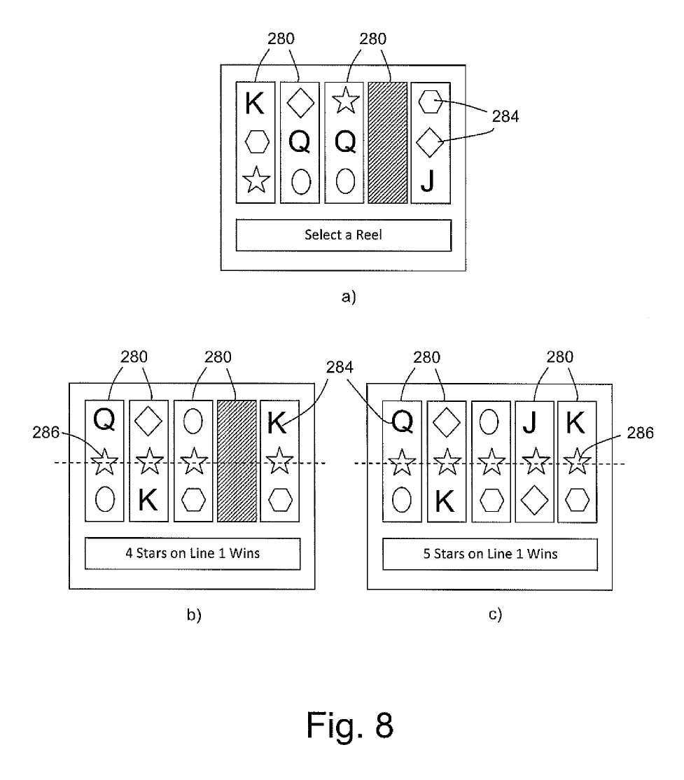

A specific example will now be described in relation to flow diagram 250 shown in FIG. 7, which illustrates steps 252 to 270 of a method of gaming implemented by the gaming system according to the present embodiment, and representations of the display area shown in FIGS. 8a to 8c.

In this example, the gaming system comprises 5 reels 280

arranged to display standard symbols and one or more function symbols during implementation of a base game. Win outcomes are determined on the basis of the symbols visible at the display positions when the reels stop.

Typically, a player will purchase or otherwise obtain win entitlements such as several win lines which are used in the game to determine win outcomes. If the displayed symbols on the reels have symbols associated with a winning combination such as a winning combination disposed on a win line, the player wins a prize.

During normal game mode, all 5 reels 280 are visible. The reels spin and are subsequently controlled by the reel controller 21 to stop such that selected symbols are displayed. The displayed symbols are then evaluated by the outcome evaluator 28 and if the displayed symbols correspond to a winning outcome, a prize is awarded by the prize allocator 29.

If a trigger condition exists, for example if one or more defined symbols are displayed, the trigger determiner 23 identifies the trigger condition and instigates special game mode wherein at least one feature game is implemented.

As shown in FIG. 8a, during a feature game at least one reel 280 is selected and the selected reel is obscured by a shutter 282. In this example, the shutter 282 is a mechanical shutter movable between a first position, as shown in FIG. 8a, wherein a reel is obscured by the shutter 282 and a second position wherein the reel is not obscured by the shutter 282 and the reel 280 is visible to a player. Also in this example, the reel to be obscured by the shutter 282 is selected by the player, for example using a touch screen or a button on the gaming machine, although it will be understood that the reel may be selected by the gaming system, for example randomly using the random number generator 22.

After the selected reel is obscured by the shutter 282, the 5 reels spin and are subsequently controlled by the reel controller 21 to stop such that selected symbols 284 in 4 of the reels are visible and selected symbols on one of the reels are obscured from view by the shutter 282, as shown in FIG. 8b. The visible symbols 284 are then evaluated by the outcome evaluator 28 and if the visible symbols correspond to a winning outcome, a prize is awarded by the prize allocator 29.

In the example shown in FIG. 8b, the visible symbols correspond to a winning outcome comprising 4 star symbols 286, and a prize associated with 4 star symbols is awarded.

As shown in FIG. 8c, the shutter 282 is then caused to open so as to make the previously concealed symbols of the concealed reel visible, and the visible symbols are evaluated by the outcome evaluator 28. If the visible symbols correspond to a winning outcome, a prize is awarded by the prize allocator 29.

In the example shown in FIG. 8c, the visible symbols correspond to a winning outcome comprising 5 star symbols 286, and a prize associated with 5 star symbols is awarded.

As an alternative, instead of obscuring one reel with a shutter, the gaming system may be arranged to obscure more than one reel, with each reel being selected by a player or selected randomly by the gaming system. With this implementation, the selected reels may be obscured and revealed at the same time, or the reels may be obscured together, each reel revealed individually and a game outcome evaluated after each reel is revealed.

With this alternative embodiment, each previously concealed reel that is to be revealed may be selected by a player or randomly by the gaming system, for example such that the order of reels that are revealed is determined by the player or randomly by the gaming system.

For implementations that are arranged to obscure more than one reel, subsequent reels may be revealed in response to a game condition, such as a random trigger or display of a particular symbol or combination of symbols.

As a further alternative, instead of obscuring one or more reel, the or each selected reel may be made less visible than the reels that have not been selected. This may be achieved by modifying lighting associated with the gaming system such that selected reels are not illuminated or illuminated less than reels that have not been selected.

While the present embodiment is described in relation to a mechanical type base game, it will be understood that other arrangements are envisaged. For example, the reels may be virtual reels shown on a display device.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and variations as would be apparent to a skilled addressee are determined to be within the scope of the present invention.

1. A gaming system comprising:
a selector arranged to select a plurality of symbols from a set of symbols for display in a display position area in a plurality of display position groups;
the gaming system being arranged to facilitate selection of at least one display position group;
the gaming system being arranged so as to make symbols in the at least one selected display position group less visible than symbols in other non-selected display position groups; and
the gaming system being arranged so as to:
determine a first game outcome based on symbols displayed in the non-selected display position groups when symbols of the at least one selected display position group are less visible than symbols in the non-selected display position groups;
after the first game outcome is determined, to make the symbols in at least one selected display position group as visible as symbols in the non-selected display position groups; and
after making the symbols in the at least one selected display position group as visible as symbols in the non-selected display position groups, determine a second game outcome based on symbols displayed in the non-selected display position groups and symbols displayed in the at least one selected display position group that has been made as visible as symbols in the non-selected display position groups.

2. A gaming system as claimed in claim 1, comprising at least one shutter member disposable in a first configuration wherein the at least one selected display position group is concealed, and in a second configuration wherein the at least one selected display position group is not concealed.

3. A gaming system as claimed in claim 2, wherein each display position group has an associated shutter member movable between a closed position wherein the associated display position group is concealed and an open position wherein the associated display position group is not concealed.

4. A gaming system as claimed in claim 2, wherein the at least one shutter member is operable in a substantially transparent state wherein at least one display position group is visible through the shutter member, and in a substantially non-transparent state wherein the at least one display position group is not visible through the shutter member.

5. A gaming system as claimed in claim 4, wherein each display position group has an associated shutter member operable in a transparent or non-transparent state.

6. A gaming system as claimed in claim 1, wherein the gaming system is arranged so as to selectively make symbols in the at least one selected display position group less visible than, or as visible as, symbols in non-selected display position groups by modifying lighting associated with the at least one selected display position group.

7. A gaming system as claimed in claim 1, wherein the gaming system is arranged to automatically select the at least one display position group to be made less visible than symbols in non-selected display position groups.

8. A gaming system as claimed in claim 1, wherein the gaming system is arranged to facilitate selection by a player of the at least one display position group to be made less visible than symbols in non-selected display position groups.

9. A gaming system as claimed in claim 8, comprising a touch screen and/or one or more buttons usable by a player to select the at least one display position group to be made less visible than symbols in other non-selected display position groups.

10. A gaming system as claimed in claim 1, wherein the gaming system is arranged to facilitate selection of a plurality of display position groups, and to make symbols in the selected display position groups less visible than symbols in non-selected display position groups.

11. A gaming system as claimed in claim 10, wherein, after the first game outcome is determined, the gaming system is arranged to make the symbols in all selected display position groups as visible as symbols in the non-selected display position groups.

12. A gaming system as claimed in claim 10, wherein, after the first game outcome is determined, the gaming system is arranged to:
sequentially make the symbols in the selected display position groups as visible as symbols in the non-selected display position groups, and
after making the symbols in each of the selected display position groups as visible as symbols in the non-selected display position groups, determine subsequent respective game outcomes based on symbols displayed in the non-selected display position groups and symbols displayed in the selected display position groups that have been made as visible as symbols in the non-selected display position groups.

13. A gaming system as claimed in claim 12, wherein, after the first game outcome is determined, the gaming system is arranged to:
facilitate selection by a player of at least one of the selected display position groups to be made as visible as symbols in the non-selected display position groups.

14. A gaming system as claimed in claim 1, comprising a plurality of reels, each reel being associated with a display position group.

15. A gaming system as claimed in claim 14, wherein the reels are physical reels or virtual reels.

16. A gaming system as claimed in claim 1, wherein the system is operable in base game mode or special game mode, and wherein:
in base game mode, at least one display position group to be made less visible than symbols in non-selected display position groups is not selected; and
in special game mode, at least one display position group to be made less visible than symbols in other non-selected display position groups is selected.

17. A gaming system as claimed in claim 16, wherein the gaming system is arranged to commence special game mode when a trigger condition occurs.

18. A method of gaming comprising:
selecting a plurality of symbols from a set of symbols for display in a display position area in a plurality of display position groups;
selecting at least one display position group;
making symbols in the at least one selected display position group less visible than symbols in other non-selected display position groups; and
determining a first game outcome based on symbols displayed in the non-selected display position groups when symbols of the at least one selected display position group are less visible than symbols in the non-selected display position groups;
after the first game outcome is determined, making the symbols in at least one selected display position group as visible as symbols in the non-selected display position groups; and
after making the symbols in the at least one selected display position group as visible as symbols in the non-selected display position groups, determining a second game outcome based on symbols displayed in the non-selected display position groups and symbols displayed in the at least one selected display position group that has been made as visible as symbols in the non-selected display position groups.

19. A method as claimed in claim 18, comprising providing at least one shutter member disposable in a first configuration wherein the at least one selected display position group is concealed, and in a second configuration wherein the at least one selected display position group is not concealed.

20. A method as claimed in claim 19, wherein each display position group has an associated shutter member movable between a closed position wherein the associated display position group is concealed and an open position wherein the associated display position group is not concealed.

21. A method as claimed in claim 19, comprising providing at least one shutter member is operable in a substantially transparent state wherein at least one display position group is visible through the shutter member, and in a substantially non-transparent state wherein the at least one display position group is not visible through the shutter member.

22. A method as claimed in claim 21, comprising providing each display position group with an associated shutter member operable in a transparent or non-transparent state.

23. A method as claimed in claim 18, comprising selectively making symbols in the at least one selected display position group less visible than, or as visible as, symbols in non-selected display position groups by modifying lighting associated with the at least one selected display position group.

24. A method as claimed in claim 18, comprising automatically selecting the at least one display position group to be made less visible than symbols in non-selected display position groups.

25. A method as claimed in claim 18, comprising receiving selection by a player of the at least one display position group to be made less visible than symbols in non-selected display position groups.

26. A method as claimed in claim 25, comprising providing a touch screen and/or one or more buttons usable by a player to select the at least one display position group to be made less visible than symbols in other non-selected display position groups.

27. A method as claimed in claim 18, comprising selecting a plurality of display position groups, and making symbols in the selected display position groups less visible than symbols in non-selected display position groups.

28. A method as claimed in claim 27, comprising, after the first game outcome is determined, making the symbols in all selected display position groups as visible as symbols in the non-selected display position groups.

29. A method as claimed in claim 27, comprising, after the first game outcome is determined:
sequentially making the symbols in the selected display position groups as visible as symbols in the non-selected display position groups, and
after making the symbols in each of the selected display position groups as visible as symbols in the non-selected display position groups, determining subsequent respective game outcomes based on symbols displayed in the non-selected display position groups and symbols displayed in the selected display position groups that have been made as visible as symbols in the non-selected display position groups.

30. A method as claimed in claim 29, comprising, after the first game outcome is determined:
receiving selection by a player of at least one of the selected display position groups to be made as visible as symbols in the non-selected display position groups.

31. A method as claimed in claim 18, comprising providing a plurality of reels, each reel being associated with a display position group.

32. A computer readable data storage device having a computer readable program code embodied therein for causing a computer to operate in accordance with a gaming system comprising:
a selector arranged to select a plurality of symbols from a set of symbols for display in a display position area in a plurality of display position groups;
the gaming system being arranged to facilitate selection of at least one display position group;
the gaming system being arranged so as to make symbols in the at least one selected display position group less visible than symbols in other non-selected display position groups; and
the gaming system being arranged so as to:
determine a first game outcome based on symbols displayed in the non-selected display position groups when symbols of the at least one selected display position group are less visible than symbols in the non-selected display position groups;
after the first game outcome is determined, to make the symbols in at least one selected display position group as visible as symbols in the non-selected display position groups; and
after making the symbols in the at least one selected display position group as visible as symbols in the non-selected display position groups, determine a second game outcome based on symbols displayed in the non-selected display position groups and symbols displayed in the at least one selected display position group that has been made as visible as symbols in the non-selected display position groups.
